(19) United States
(12) Patent Application Publication
(10) Pub. No.: US 2024/0221194 A1
(43) Pub. Date: Jul. 4, 2024

(54) DEPTH ESTIMATION FOR MONOCULAR SYSTEMS USING ADAPTIVE GROUND TRUTH WEIGHTING

(71) Applicant: QUALCOMM Incorporated, San Diego, CA (US)

(72) Inventors: Amin Ansari, Federal Way, WA (US); Yunxiao Shi, San Diego, CA (US); Sai Madhuraj Jadhav, San Diego, CA (US); Avdhut Joshi, San Marcos, CA (US)

(21) Appl. No.: 18/148,816

(22) Filed: Dec. 30, 2022

(51) Int. Cl. G06T 7/50; G06T 7/11

(52) U.S. Cl. CPC G06T 7/50; G06T 7/11; G06T 2207/30252

(57) ABSTRACT

This disclosure provides systems, methods, and devices for vehicle driving assistance systems that support image processing. In a first aspect, a computing device receives a predicted depth map determined by a model and determines differences between the predicted depth map and a depth mask. The depth mask may be predetermined to include values indicating a probability that a corresponding region of the predicted depth map is a sky region. A first loss term for the predicted depth map is determined based on the differences and the model is trained based on the first loss term. Other aspects and features are also claimed and described.

### TECHNICAL FIELD

Aspects of the present disclosure relate generally to driver-operated or driver-assisted vehicles, and more particularly, to methods and systems suitable for supplying driving assistance or for autonomous driving.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Human operators of vehicles can be distracted, which is one factor in many vehicle crashes. Driver distractions can include changing the radio, observing an event outside the vehicle, and using an electronic device, etc. Sometimes circumstances create situations that even attentive drivers are unable to identify in time to prevent vehicular collisions. Aspects of this disclosure, provide improved systems for assisting drivers in vehicles with enhanced situational awareness when driving on a road.

Example embodiments provide an improved system for training a depth estimation model. Learning depth from a monocular camera can be done in multiple ways (self-supervision, full-supervision, partial supervision), but may still result in artifacts in resulting predicted depth maps. In particular, artifacts related to the sky region may challenging to address, as correctly predicting depth for the sky may be challenging. The presently discussed techniques may use a static mask to guide the depth of pixels within sky regions to a higher depth to accelerate training by providing a strong prior for all pixels. A pull loss function may be added (to speed up convergence) to the set of loss terms, and weights for the pull loss function may be imposed for loss calculation during training of the model.

In certain embodiments, a computing device may receive a predicted depth map, which may be determined based on one or more image frames. The predicted depth map may be compared to a depth mask, which may include higher depth values for typical sky regions within depth maps, such as depth maps predicted by the model. For example, in certain implementations, the depth values may increase within the depth mask according to an elliptic paraboloid function. A pull loss term may then be determined based on the differences between the predicted depth map and the depth mask. The model may then be trained based on the pull loss term. In certain instances, training the model may include determining a second loss term for one or more predicted depth maps. In such instances, the pull loss term may be weighted during determination of the second loss term. For example, the weight may decrease as training of the model progresses (such as based on a total number of training runs completed by the model). The model may then be updated based on the second loss term.

In one embodiment, an apparatus is provided that includes a memory storing processor-readable code and at least one processor coupled to the memory. The at least one processor may be configured to execute the processor-readable code to cause the at least one processor to perform operations including receiving a predicted depth map determined by a model; determining differences between the predicted depth map and a depth mask, where the depth mask is predetermined to include values indicating a probability that a corresponding region of the predicted depth map is a sky region; determining, based on the differences, a first loss term for the predicted depth map; and training the model based on the first loss term.

In another embodiment, a method is provided that includes receiving a predicted depth map determined by a model. The method also includes determining differences between the predicted depth map and a depth mask, where the depth mask is predetermined to include values indicating a probability that a corresponding region of the predicted depth map is a sky region. The method also includes determining, based on the differences, a first loss term for the predicted depth map. The method also includes training the model based on the first loss term.

In another embodiment, a non-transitory computer-readable medium is provided storing instructions that, when executed by a processor, cause the process to perform operations including receiving a predicted depth map determined by a model. The operations also include determining differences between the predicted depth map and a depth mask, where the depth mask is predetermined to include values indicating a probability that a corresponding region of the predicted depth map is a sky region. The operations also include determining, based on the differences, a first loss term for the predicted depth map. The instructions also includes training the model based on the first loss term.

In a further embodiment, a system is provided that includes an image sensor configured to capture image frames from a vehicle. The system also includes a memory storing instructions and a processor. The processor may be configured to execute the instructions to: receive a predicted depth map determined by a model; determine differences between the predicted depth map and a depth mask, where the depth mask is predetermined to include values indicating a probability that a corresponding region of the predicted depth map is a sky region; determine, based on the differences, a first loss term for the predicted depth map; and train the model based on the first loss term.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle with a driver monitoring system according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIG. 4 is a block diagram illustrating a system for training a model for depth estimation according to an exemplary embodiment of the present disclosure.

FIG. 5A depicts a graph of an elliptic paraboloid according to an exemplary embodiment of the present disclosure.

FIG. 5B a graph of a weighting function according to an exemplary embodiment of the present disclosure.

FIG. 6 is a flow chart illustrating an example method for training a model for depth estimation according to an exemplary embodiment of the present disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support improved training of depth estimation models. Dense (or sparse) depth estimation may be useful to a variety of applications, including autonomous driving, assistive robotics, AR/VR scene composition, image editing, and the like. In various implementations, depth estimation can be done by leveraging different principles, such as calibrated stereo, multi-view stereo, machine learning from monocular videos, structure from motion (SFM), and the like. Monocular depth estimation using a single image sensors, or multiple image sensors with a single view and may be preferable in various implementations. For example, stereo setups may be costly and difficult to keep calibrated and multi-view setups may suffer from various difficulties, including a high baseline, synchronization issues, low overlapping regions, and the like. Furthermore, monocular cameras are ubiquitous in auto industry and thus may be widely available for use in depth estimation for automotive applications. In certain implementations, monocular techniques may even be used with dashcam footage.

Machine learning techniques for depth estimation from monocular imaging setups may be implemented using various techniques. Self-supervision techniques may use a temporal axis between captured image frames to infer depth and may use joint learning of depth and ego-motion using self-supervision. Such techniques may also leverages SFM principles to do view synthesis as the (self) supervision signal. Such techniques may eliminate the need for depth ground truth during the training process and may be compelling use cases when there may be an abundance of video data. Full supervision techniques leverage external measurements of ground truth depth data to learn mappings from images to dense depth maps. Partial supervision techniques may rely mainly on self-supervision techniques, but may additionally apply full supervision techniques to a small set of pixels within captured images. Such techniques can help resolve the scale ambiguity common to self supervision training.

While training depth models, sky artifacts may be particular common, where predicted depth maps indicate inaccurate depth values for portions of an image depicting the sky. Such artifacts may be extremely difficult to fix, as sky regions may typically have limited textures within captured images, making feature matching impractical. In addition, range-finding sensors do not typically get measured returns from the sky, so explicit supervision may not resolve the issue. Masking out the sky region may be data-dependent and may be difficult to generalize. Furthermore, data from bumpy roads can exacerbate sky artifacts, as the location of the sky within an image frame is rapidly changing.

One solution to this problem may be to use a depth mask as a static mask for predicted depth maps during training. The depth mask may initially guide predicted depth values of pixels within predicted depth maps during training. In particular, the depth mask may be used reduce sky artifacts by pushing pixel in typical sky regions to higher depth values (such as approaching a maximum depth value). This may accelerate training by providing a strong prior for pixels within predicted depth maps that reflect typical or average scenes. Such improvements to the training may also improve training by improving accuracy of a final trained model, such as by causing the training process to approach a better point on a loss manifold of the model earlier.

Stated differently, learning depth from a monocular camera can be done in multiple ways (self-supervision, full-supervision, partial supervision), but may still result in artifacts in resulting predicted depth maps. In particular, artifacts related to the sky region may challenging to address, as correctly predicting depth for the sky may be challenging. The presently discussed techniques may use a static mask to guide the depth of pixels within sky regions to a higher depth to accelerate training by providing a strong prior for all pixels. A pull loss function may be added (to speed up convergence) to the set of loss terms, and weights for the pull loss function may be imposed for loss calculation during training of the model.

Particular implementations of the subject matter described in this disclosure may be implemented to realize one or more of the following potential advantages or benefits. In some aspects, the present disclosure provides techniques for image processing that may be particularly beneficial in smart vehicle applications. For example, the discussed techniques may result in considerable improvement to the operation of computing devices. In particular, depth map estimations from a model improve considerably in accuracy when used after training according to the described adaptive weighting system. Furthermore, training time may be reduced for the same (or even an improved) level of model accuracy. Furthermore, the improved operational benefits of a model occur with the same or similar levels of utilized computing resources, as the weighting operations occur during training of the model.

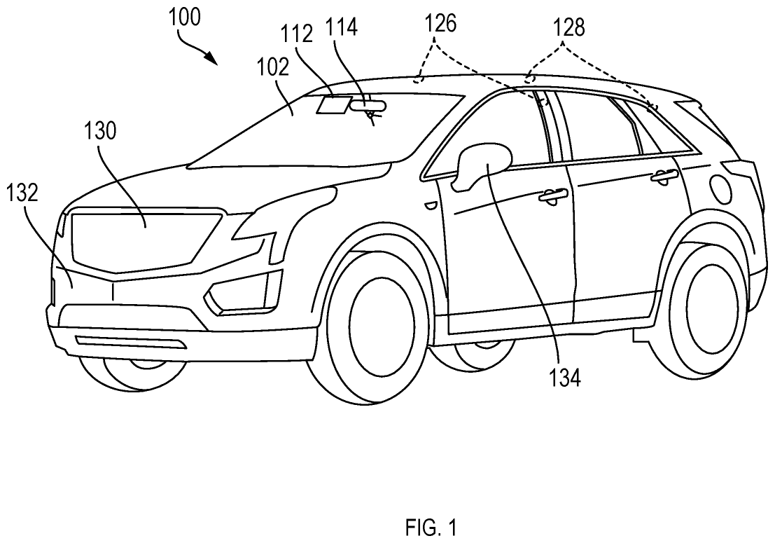

FIG. 1 is a perspective view of a motor vehicle with a driver monitoring system according to embodiments of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or in a forward direction. In some embodiments, an additional camera may be located at the rear of the vehicle 100 and oriented such that the field of view of the additional camera captures a scene behind the vehicle 100 in the direction that the vehicle 100 is moving when in reverse mode or in a reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the vehicle 100 is traveling in a forward direction may likewise be obtained while the vehicle 100 is traveling in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

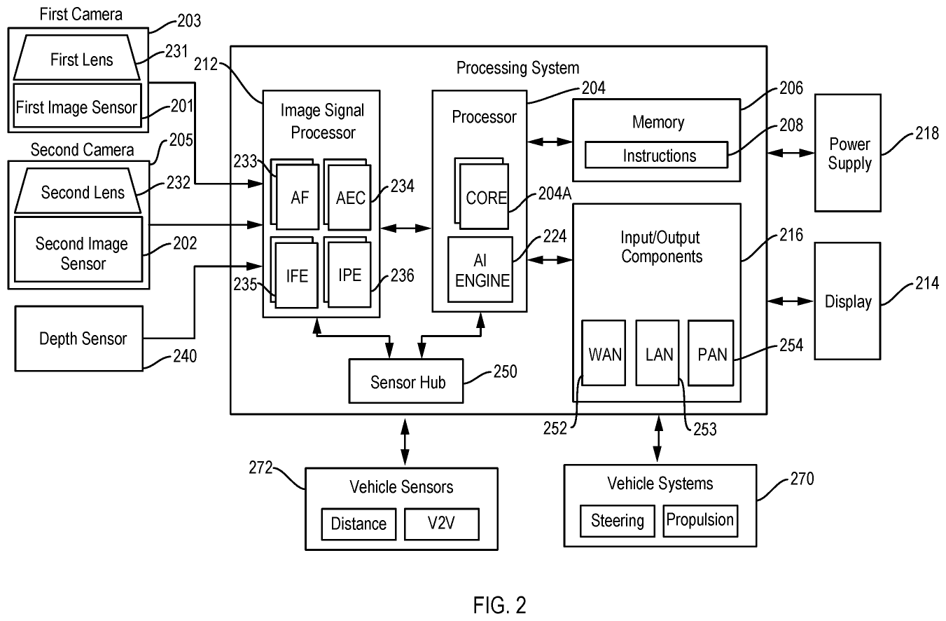

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor (e.g., CPU) 204 and a memory 206 storing instructions 208. The vehicle 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some embodiments, the vehicle 100 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination).

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

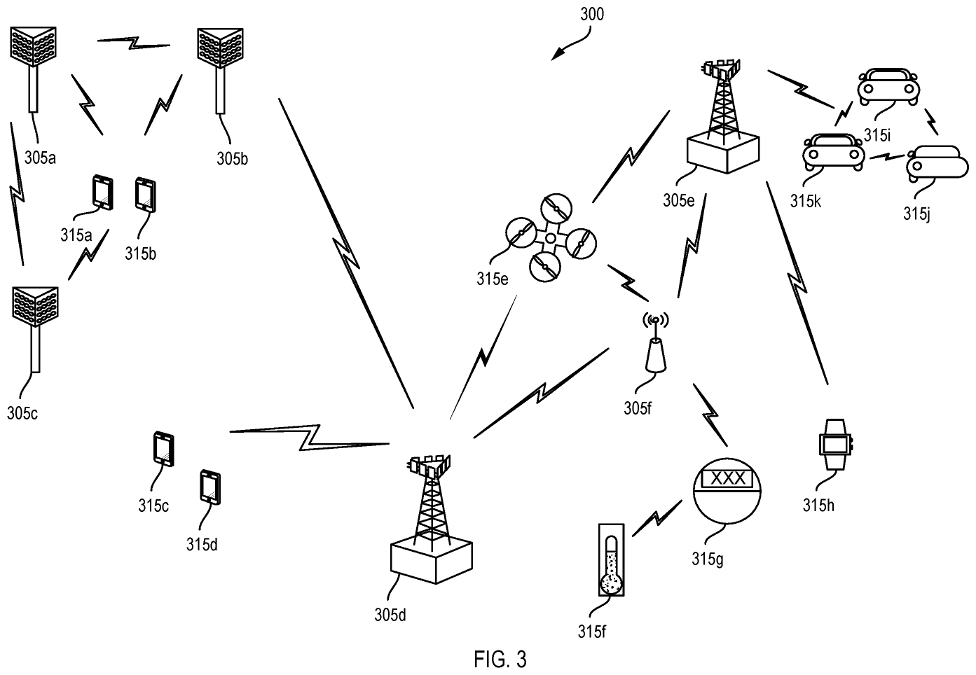

The vehicle 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports mission critical communications with ultra-reliable and redundant links for mission critical devices, such UE 315e, which is a drone. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305e.

Aspects of the vehicular systems described with reference to, and shown in, FIG. 1, FIG. 2, and FIG. 3 may include one or more models (such as machine learning models) that are configured to estimate depth measurements to objects within view of an imaging system (such as a monocular imaging system) of the vehicle. The depth measurements may then be used to control the vehicle, alert an operator of the vehicle, or combinations thereof.

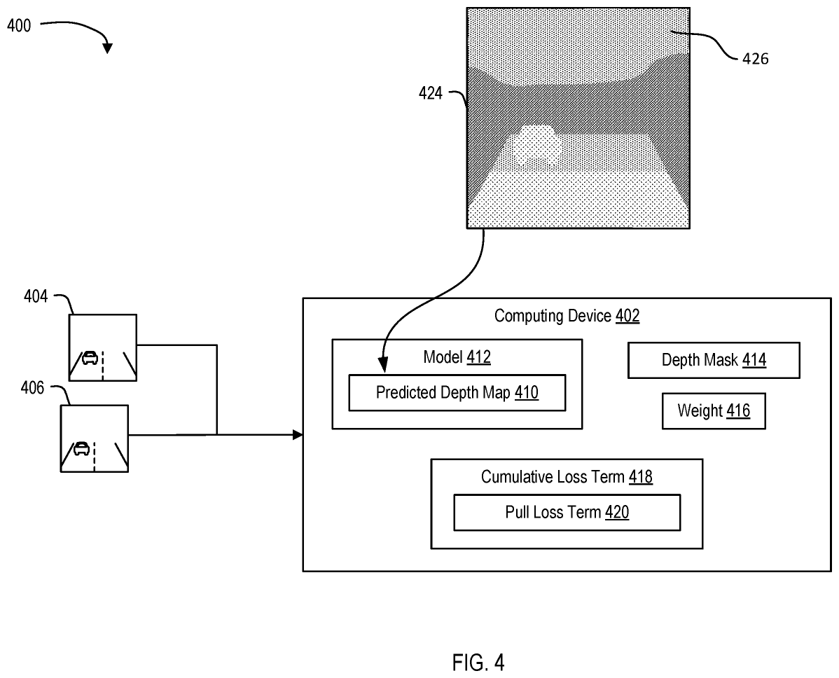

FIG. 4 is a block diagram illustrating a system 400 for training a model for depth estimation according to an exemplary embodiment of the present disclosure. The system 400 includes image frames 404, 406, a measured depth map 408, and a computing device 402. The computing device 402 includes a model 412, a cumulative loss term 418, a depth mask 414, and a weight 416. The model 412 includes a predicted depth map 410 and the cumulative loss term 418 includes a pull loss term 420. The computing device 402 may be implemented as a computing device within a vehicle, such as the processing system in FIG. 2. In still further implementations, the computing device 402 may be implemented by a computing device external to a vehicle, such as a personal computing device, server computing device, smartphone device, laptop computing device, and the like. In certain implementations, the computing device 402 may be implemented by multiple computing devices.

The computing device 402 may be configured to receive a predicted depth map 410. In certain implementations, the predicted depth map 410 may be determined by a model 412. For example, the model 412 may be configured to receive one or more image frames 404, 406 and generate predicted depth maps 410 at multiple times based on the image frames 404, 406. In particular, the model 412 may receive a sequence of image frames 404, 406 and may use the sequence of image frames to generate the predicted depth maps 410. For example, the image frame 404 may be a current image frame of a sequence of image frames (such as an image frame that is currently being processed) and the image frame 406 may be a neighboring image frame for the image frame 404. In certain instances, the image frame 406 may be an image frame that occurs within a predetermined time period of the image frame 404, a predetermined number of frames from the image frame 404, or combinations thereof. For example, the image frame 406 may immediately precede the image frame 404 within a sequence of image frames. In certain implementations, the image frames 404, 406 may be captured by an image system on a vehicle, such as a monocular imaging system 400. For example, the image frames 404, 406 may be captured by one or more cameras 112, 114 on the vehicle 100. In certain implementations, other imaging systems may be utilized. In certain implementations, the neighboring image frames 406 may include more than one image frame.

The predicted depth map 410 may contain predicted depth values for objects depicted in corresponding pixels of the image frame 404. For example, all or a subset of the pixels within the image frame 404 may have a corresponding predicted depth value within the predicted depth map 410. The predicted depth values may reflect a predicted distance between an image sensor that captured the image frame 404 and an object or region depicted within a corresponding pixel of the image frame 404.

In certain implementations, the depth map 410 may indicate depths for corresponding regions of the image frame 404, such as distance to a point depicted within a corresponding pixel of the image frame 404. In further implementations, one or both of the depth map 410 may be implemented as disparity maps, which may be computed as the inverse of the measured or predicted depths at each location within the depth map 410.

For example, FIG. 4 also includes an example depth map 424, which may be an exemplary implementation of the predicted depth map 410. The depth map 424 includes darker shading to indicate regions with a larger predicted distance (such as distance in front of a vehicle to an object depicted within a corresponding portion of the image frame 404). Notably, however, the depth map 424 includes a sky artifact 426, in which a closer distance is predicted for the sky than would be correct, given that there is no obstacle within the corresponding portion of the image frame 404.

The computing device 402 may be configured to determine differences between the predicted depth map 410 and a depth mask 414. The depth mask 414 may be predetermined to include values indicating a probability that corresponding regions of the predicted depth map 410 are sky region (such as regions that are likely to depict sky within captured image frames). In particular, the depth mask 414 may be predetermined to include higher depth values for typical sky regions within depth maps. For example, the typical sky regions may be indicated within the depth mask 414 based on typical locations of sky within a field of view in front of a vehicle. In certain implementations, the depth mask depth mask 414 may trend toward a maximum predicted depth (such as 100 m) as corresponding portions of image frames are more likely to depict sky (such as based on a typical camera arrangement used to capture image frames by the same or similar vehicle 100). In certain implementations, depth values of the depth mask 414 increase for higher vertical regions of the depth mask 414. In certain implementations, the depth mask 414 may have higher depth values (such as 75% or more of a maximum depth value) for depth values located above a typical horizon location in level driving conditions. In the depicted examples, the location of the horizon is approximately located near the vertical center of the depth map 424, but other implementations may be utilized, depending on camera arrangements and typical driving conditions.

In certain implementations, depth values for the depth mask 414 may increase according to a parabolic function, such as an elliptic paraboloid function. In particular, in level driving conditions, for image frames 404, 406 captured at two different locations, the disparity in the location of a pixel in both image frames 404 may be inversely proportional to a depth to the pixel (such as an object depicted in the pixel). As noted above, disparity values are typically determined based on the inverse of depth measures. If a Jacobian is taken for the depth, the Jacobian (and a corresponding depth mask value) may scale according to the inverse square of the disparity. Accordingly, the values (such as values indicating a disparity measure) for the depth mask 414 may increase according to a quadratic function, such as a parabolic function.

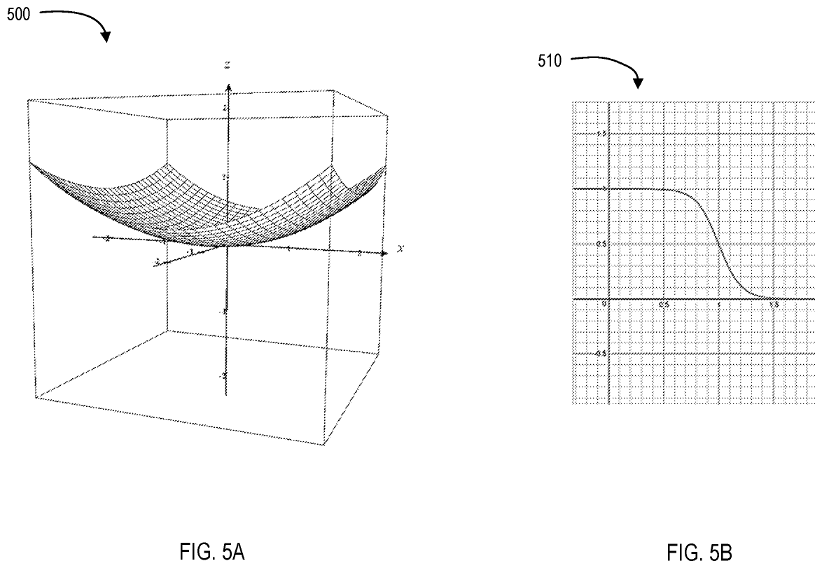

In certain implementations, the depth mask 414 may be predetermined to include depth values that increases as an elliptic paraboloid within the depth mask 414, such as the elliptic paraboloid depicted in graph 500 of FIG. 5A. For example, depth values for the depth mask 414 may be determined as:

$$d ( x , y ) = a * {( x - width / 2 )}^{∧} 2 + b * {( y - height )}^{∧} 2 + c ,$$

where (x, y) are pixel indices or coordinates within the image frame 404; d is the depth for the pixel located at (x,y); and a, b and c are data-dependent coefficients (which may be preconfigured or tuneable). Using such a formulation of the depth mask 414 may accordingly enable an accurate representation of the likelihood that corresponding pixels correspond to typical sky regions within images and depth maps for an imaging system (such as a vehicle imaging system).

As indicated in this example, the elliptic paraboloid function used to determine the depth values of depth mask 414 may have an origin at one or more pixels located at or near an edge of the depth mask 414, such as the bottom edge. In certain implementations, pixels located at or near an edge of the depth mask 414 may include pixels located within 10% of the corresponding edge (such as along an axis perpendicular to the corresponding edge). In certain implementations, the depth mask 414 may be off center on the edge, such as to account for positioning of a camera system relative to a vehicle.

In certain implementations, determining the differences may include comparing depth values from the predicted depth map 410 and the depth mask 414. In certain implementations, the differences include different depth values between regions of the predicted depth map 410 and corresponding regions of the depth mask 414. In certain implementations, the computing device 402 may compare, for each pixel or pixel region within the predicted depth map 410, depth value(s) from the predicted depth map 410 to depth value(s) from a corresponding pixel or pixel region within the depth mask 414. In certain instances, individual pixels may be compared to one another between the predicted depth map 410 and the depth mask 414. In additional or alternative implementations, pixel regions (such as 2×2 pixel regions, 3×3 pixel regions, and the like) may be compared to one another between the predicted depth map 410 and the depth mask 414.

The computing device 402 may be configured to determine, based on the differences, a pull loss term 420 for the predicted depth map 410. In certain implementations, the pull loss term 420 may be computed based on the differences between predicted depths within the predicted depth map 410 and depth values within the depth mask 414. In certain implementations, for example, differences between the depth mask 414 and corresponding regions of the predicted depth map 410 may be combined to generate a pull loss term 420 corresponding to the image frame 404. In certain instances, combining the differences may include summing the differences together, summing the absolute value of the differences, averaging the differences, averaging the absolute value of the differences, determining a maximum difference, determining a minimum difference, or combinations thereof. One skilled in the art will appreciate that various techniques (such as various statistical techniques) may be used to combine differences between the depth mask 414 and the predicted depth map 410 to determine a pull loss term 420. Differences for portions of a predicted depth map 410 that contain a sky artifact 426 are likely to be larger given the above-described configuration of the depth mask 414. Accordingly, the pull loss term 420 is likely to be larger if a predicted depth map 410 contains a sky artifact 426, resulting in a penalty for the model 412 during training.

The computing device 402 may be configured to train the model 412 based on the pull loss term 420. In certain implementations, the model 412 may be trained using a supervised training process. In certain implementations, the computing device 402 may be configured to train a model 412 based on the pull loss term 420. For example, the model 412 may be trained to determine predicted depth maps 410 based on image frames 404, 406 (such as individual image frames 404, 406, sequences of image frames 404, 406, or combinations thereof) captured by an image sensor (such as a monocular image sensor).

In certain implementations, training the model 412 may include determining or adjusting a cumulative loss term 418 for the model 412 based on the pull loss term 420. In particular, the cumulative loss term 418 may be used to train the model 412. For example, the cumulative loss term 418 may be incorporated as part of an objective function (such as part of a penalty for the objective function) for the model 412. In certain implementations, the cumulative loss term 418 may be determined based on multiple pull loss terms 420, such as pull loss terms based on predicted depth maps and corresponding measured depth maps for multiple image frames from a sequence of image frames for multiple image frames). For example, the multiple pull loss terms may be combined to form a combined pull loss term that is used to determine the cumulative loss term 418. In still further implementations, other loss terms may be incorporated into the cumulative loss term 418. For example, a smoothness loss term may be computed based on how smoothly depth values change within the predicted depth map 410 and a photometric loss term may be computed based on how closely a reconstructed image based on the predicted depth map 410 resembles the image frame 404. In practice, additional or alternative loss terms may also be computed based on the predicted depth map 410 and corresponding image frames 404. These loss terms may be combined with the pull loss term 420 to form the cumulative loss term 418. For example, the cumulative loss term 418 may be computed according to an objective function that specifies a weighted combination of one or more loss terms.

In certain implementations, the pull loss term 420 may be weighted according to a weight 416 when determining the cumulative loss term 418. For example, the pull loss term 420 may be multiplied by the weight 416 when being combined with other loss terms to form the cumulative loss term 418. In certain implementations, the depth mask 414 may serve as a strong prior during training, but may be relatively coarse. Accordingly, the influence of the pull loss term 420 may have weaker influence over the cumulative loss term 418 as training continues. For example, training the model 412 may include determining multiple loss terms for multiple predicted depth maps 410, and the multiple loss terms may include corresponding pull loss terms 420. In certain implementations, the cumulative loss term 418 for the model 412 may be determined based on the multiple loss terms before updating the model 412 based on the cumulative loss term 418.

To adjust the influence of the pull loss term for multiple training runs, the weight 416 may decrease for predicted depth maps 410 generated later in a training process for the model 412. For example, the computing device 402 may decrease the weight 416 or otherwise compute the weight 416 according to a predetermined function based on how many training runs have been completed (such as how many predicted depth maps have been generated and compared to the depth mask 414, how many sequences of images have been analyzed, or combinations thereof). In certain implementations, the weight 416 may be determined according to a sigmoid weighting function during the training process, such as the sigmoid function depicted in graph 510 of FIG. 5B. In additional or alternative implementations, other weighting functions may be used, such as linear weighting functions, piecewise linear functions, bucketing functions, and the like. In certain implementations, the weight may maintain a steady state towards the end of training or as training continues past a predetermined point (such as a predetermined number of training runs). For example, the weight 416 may be limited to a minimum value past the predetermined point. As noted above, the discussed and depicted weighting functions are merely exemplary and, in practice, additional or alternative implementations may be used. For example, training or other analysis may identify a particular weighting function (such as a linear weighting function with particular slope(s) or a nonlinear weighting function with a particular shape) results in optimal performance for a particular training process. As another example, a weighting function may fall to 0 for training runs past a particular point.

In certain implementations, the model 412 may be trained using a supervised training process, such as a fully supervised or partially supervised training process. The model 412 may be updated based on the cumulative loss term 418. For example, the model 412 may be implemented as one or more machine learning models, including supervised learning models, unsupervised learning models, other types of machine learning models, and/or other types of predictive models. For example, the model 412 may be implemented as one or more of a neural network, a transformer model, a decision tree model, a support vector machine, a Bayesian network, a classifier model, a regression model, and the like. Parameters of the model 412 may be updated based on whether the model 412 generates correct outputs when compared to the expected outputs (as indicated by a value of the cumulative loss term 418). One or more parameter updates may be computed based on the cumulative loss term 418, such as according to a stochastic descent or other training procedure. In particular, the parameters may include weights (e.g., priorities) for different features and combinations of features (e.g., features within current image frames 404 or neighboring image frames 406). The parameter updates for the model 412 may include updating one or more of the features analyzed and/or the weights assigned to different features or combinations of features (e.g., relative to the current configuration of the model 412).

According to the above-discussed techniques, the depth mask may be used to a static mask that can initially guide predicted depth values of pixels within predicted depth maps during training. In particular, the depth mask 414 may be used to reduce sky artifacts by pushing pixel in typical sky regions to higher depth values (such as approaching a maximum depth value). This may accelerate training by providing a strong prior for pixels within predicted depth maps that reflect typical or average scenes. Such improvements to the training may also improve training by improving accuracy of a cumulative trained model, such as by causing the training process to approach a better point on a loss manifold of the model earlier.

As one particular example of these benefits, Table 1 below indicates the results of applying the above-discussed techniques in a particular scenario. In particular, results for a model trained based on 180,000 image frames using a pull loss function compared to when the model was trained without the pull loss function Error measures include Absolute Relative Error (ARE), Squared ARE, Root Mean Squared Error (RMSE), Log of RMSE, a1 Error (the percentage of data points <1.2% error), a2 Error (the percentage of data points with <1.44% error), and a3 Error (the percentage of data points with <1.73% error).

TABLE 1

| | | | Root | | | | |
|---|---|---|---|---|---|---|---|
| | Abs. | | Mean | | | | |
| | Rel. | | Squared | | | | |
| | Err. | Squared | Error | RMSE | a1 | a2 | a3 |
| | (ARE) | ARE | (RMSE) | Log | Error | Error | Error |
| No Pull | 0.068 | 1.115 | 7.907 | 0.164 | 0.940 | 0.967 | 0.982 |
| Loss | | | | | | | |
| Pull | 0.066 | 1.140 | 7.809 | 0.163 | 0.943 | 0.967 | 0.982 |
| Loss | | | | | | | |

Notably, all of the error measures show the same or improved performance using the pull loss terms when compared to training without pull loss terms. This results in considerable improvement to the operation of computing devices. In particular, depth map estimations from the model improve considerably in accuracy when used after training. Furthermore, training time may be reduced for the same (or even an improved) level of model accuracy, as the pull loss term reduces the effects of sky artifacts early in the training process. Furthermore, the improved operational benefits of the model 412 occur with the same or similar levels of utilized computing resources, as the weighting operations occur during training of the model 412.

After training the model 412, the model 412 may be subsequently used in operation to generate depth maps for use in controlling a vehicle based on image frames 404, 406 received from an imaging system 400 coupled to the vehicle. For example, the model 412 may be used as part of a system used to control a vehicle or generate alerts for an operator of the vehicle. In particular, the model 412 may be implemented by an AI engine 224. Although the vehicle 100 is depicted as an automobile, in practice the model may be used for various other types of vehicles, such as trucks, construction vehicles, motorcycles, scooters, robots, and the like. Furthermore, the model 412 may be used in other areas as well, such for augmented reality (AR)/virtual reality (VR) scene composition and image editing.

The computing device 402 may also include a processor and a memory (not depicted). The processor and the memory may implement one or more aspects of the computing device 402. For example, the memory may store instructions which, when executed by the processor, may cause the processor to perform one or more operational features of the computing device 402. The processor may be implemented as one or more central processing units (CPUs), field programmable gate arrays (FPGAs), and/or graphics processing units (GPUs) configured to execute instructions stored on the memory. Additionally, the computing device 402 may be configured to communicate using a network. For example, the computing device 402 may communicate with the network using one or more wired network interfaces (e.g., Ethernet interfaces) and/or wireless network interfaces (e.g., Wi-Fi®, Bluetooth®, and/or cellular data interfaces). In certain instances, the network may be implemented as a local network (e.g., a local area network), a virtual private network, L1, and/or a global network (e.g., the Internet).

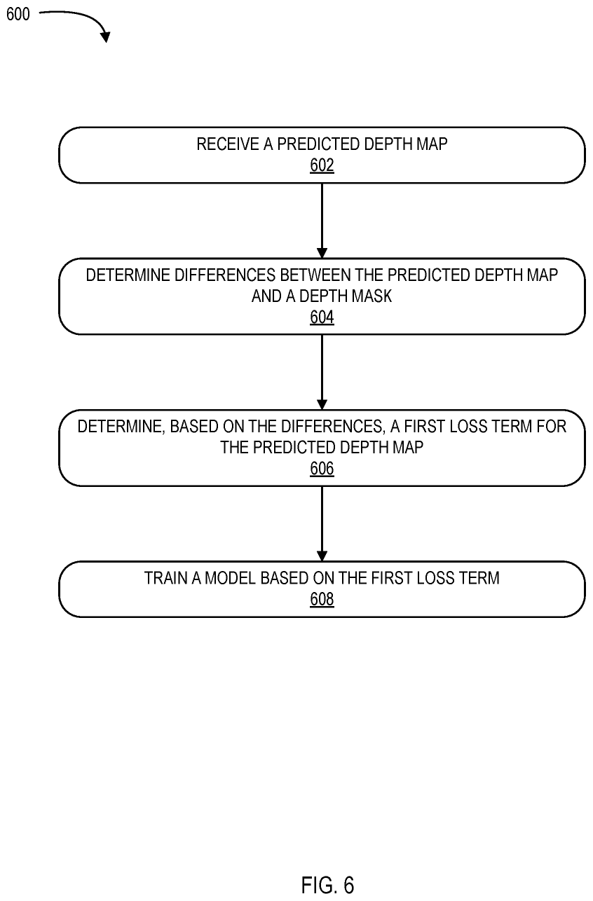

One method of performing image processing according to embodiments described above is shown in FIG. 6. FIG. 6 is a flow chart illustrating an example method 600 for training a model for depth estimation according to an exemplary embodiment of the present disclosure. The method may be performed by one or more of the above systems, such as the system 400 and the vehicle 100.

The method 600 includes receive a predicted depth map determined by a model (block 602). For example, the computing device 402 may receive a predicted depth map 410 determined by a model 412. In certain implementations, the predicted depth map 410 may be determined by the model 412 based on an image frame 404. In certain implementations, the image frame 404 may be captured by a monocular imaging system 400.

The method 600 includes determine differences between the predicted depth map and a depth mask (block 604). For example, the computing device 402 may determine differences between the predicted depth map 410 and a depth mask 414. The depth mask 414 may be predetermined to include higher depth values for typical sky regions within depth maps. In certain implementations, the typical sky regions are based on typical locations of sky within a field of view in front of a vehicle. In certain implementations, depth values of the depth mask 414 increase for higher vertical regions of the depth mask 414. In certain implementations, depth values increase as an elliptic paraboloid within the depth mask 414. In certain implementations, the elliptic paraboloid has an origin at or near the edge of the depth mask 414. In certain implementations, determining the differences may include comparing depth values from the predicted depth map 410 and the depth mask 414. The differences may include different depth values between regions of the predicted depth map 410 and corresponding regions of the depth mask 414.

The method 600 includes determining, based on the differences, a pull loss term for the predicted depth map (block 606). For example, the computing device 402 may determine, based on the differences, a pull loss term 420 for the predicted depth map 410. In certain implementations, the computing device 402 may sum or otherwise combine the differences to determine the pull loss term 420.

The method 600 includes training the model based on the pull loss term. (block 608). For example, the computing device 402 may train the model 412 based on the pull loss term 420. In certain implementations, the model 412 may be trained using a supervised training process. In certain implementations, training the model 412 further comprises adjusting a cumulative loss term 418 for the model 412 based on the pull loss term, and the cumulative loss term 418 may be used to train the model 412. In certain implementations, adjusting the cumulative loss term 418 may include applying a weight 416 to the pull loss term 420 for the predicted depth map 410. For example, the weight 416 may be applied to the pull loss term 420 when determining the cumulative loss term 418 based on the pull loss term 420. In certain implementations, the weight 416 decreases for predicted depth maps 410 generated later in a training process for the model 412. In certain implementations, the weight 416 decreases according to a sigmoid weighting function during the training process. In certain implementations, training the model 412 further includes determining multiple loss terms for multiple predicted depth maps 410, which may include the pull loss term 420 and determining a cumulative loss term 418 for the model 412 based on the multiple loss terms. In certain implementations, the model 412 may be updated based on the cumulative loss term 418.

It is noted that one or more blocks (or operations) described with reference to FIG. 6 may be combined with one or more blocks (or operations) described with reference to another of the figures. For example, one or more blocks (or operations) of FIG. 6 may be combined with one or more blocks (or operations) of FIG. 1-3. As another example, one or more blocks associated with FIG. 6 may be combined with one or more blocks associated with FIG. 4.

In one or more aspects, techniques for supporting vehicular operations may include additional aspects, such as any single aspect or any combination of aspects described below or in connection with one or more other processes or devices described elsewhere herein. A first aspect includes an apparatus. The apparatus also includes a memory storing processor-readable code. The apparatus also includes at least one processor coupled to the memory, the at least one processor configured to execute the processor-readable code to cause the at least one processor to perform operations including: receiving a predicted depth map determined by a model; determining differences between the predicted depth map and a depth mask, where the depth mask is predetermined to include values indicating probabilities that corresponding regions of the predicted depth map are sky regions; determining, based on the differences, a first loss term for the predicted depth map; and training the model based on the first loss term. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the sky regions are determined based on typical locations of sky within a field of view in front of a vehicle.

In a third aspect, in combination with one or more of the first aspect through the second aspect, probabilities of the depth mask are higher for higher vertical regions of the depth mask.

In a fourth aspect, in combination with the third aspect, probabilities increase as an elliptic paraboloid within the depth mask.

In a fifth aspect, in combination with the fourth aspect, the elliptic paraboloid has an origin at or near an edge of the depth mask.

In a sixth aspect, in combination with one or more of the first aspect through the fifth aspect, training the model further includes adjusting a second loss term for the model based on the first loss term, where the second loss term is used to train the model.

In a seventh aspect, in combination with the sixth aspect, adjusting the second loss term includes applying a weight to the first loss term for the predicted depth map.

In an eighth aspect, in combination with the seventh aspect, the weight decreases for predicted depth maps generated later in a training process for the model.

In an ninth aspect, in combination with the eighth aspect, the weight decreases according to a sigmoid weighting function during the training process.

A tenth aspect includes a method that includes receiving a predicted depth map determined by a model. The method also includes determining differences between the predicted depth map and a depth mask, where the depth mask is predetermined to include values indicating probabilities that corresponding regions of the predicted depth map are sky regions. The method also includes determining, based on the differences, a first loss term for the predicted depth map. The method also includes training the model based on the first loss term.

In a eleventh aspect, in combination with the tenth aspect, the sky regions are determined based on typical locations of sky within a field of view in front of a vehicle.

In a twelfth aspect, in combination with one or more of the tenth aspect through the eleventh aspect, probabilities of the depth mask are higher for higher vertical regions of the depth mask.

In a thirteenth aspect, in combination with the twelfth aspect, probabilities increase as an elliptic paraboloid within the depth mask.

In a fourteenth aspect, in combination with the thirteenth aspect, the elliptic paraboloid has an origin at or near an edge of the depth mask.

In a fifteenth aspect, in combination with one or more of the tenth aspect through the fourteenth aspect, training the model further includes adjusting a second loss term for the model based on the first loss term, where the second loss term is used to train the model.

In a sixteenth aspect, in combination with the fifteenth aspect, adjusting the second loss term includes applying a weight to the first loss term for the predicted depth map.

In a seventeenth aspect, in combination with the sixteenth aspect, the weight decreases for predicted depth maps generated later in a training process for the model.

In an eighteenth aspect, in combination with the seventeenth aspect, the weight decreases according to a sigmoid weighting function during the training process.

In a nineteenth aspect, in combination with one or more of the tenth aspect through the eighteenth aspect, the differences include different depth values between regions of the predicted depth map and corresponding regions of the depth mask.

In a twentieth aspect, in combination with one or more of the tenth aspect through the nineteenth aspect, the method includes, after training the model, generating, by the model, depth maps for use in controlling a vehicle based on image frames received from an imaging system coupled to the vehicle.

In a twenty-first aspect, in combination with one or more of the tenth aspect through the twenty-first aspect, the predicted depth map is determined by the model based on an image frame.

In a twenty-second aspect, in combination with the twenty-first aspect, the image frame is captured by a monocular imaging system.

A twenty-third aspect includes a non-transitory computer-readable medium storing instructions. When executed by a processor, the instructions cause the processor to perform operations that include receiving a predicted depth map determined by a model. The operations also include determining differences between the predicted depth map and a depth mask, where the depth mask is predetermined to include values indicating probabilities that corresponding regions of the predicted depth map are sky regions. The operations also include determining, based on the differences, a first loss term for the predicted depth map. The operations also include training the model based on the first loss term.

In a twenty-fourth aspect, in combination with the twelfth aspect, the sky regions are determined based on typical locations of sky within a field of view in front of a vehicle.

In a twenty-fifth aspect, in combination with one or more of the twenty-third aspect through the twenty-fourth aspect, the probabilities increase as an elliptic paraboloid within the depth mask.

In a twenty-sixth aspect, in combination with the twenty-fourth aspect, the probabilities of the depth mask are higher for higher vertical regions of the depth mask.

A twenty-seventh aspect includes a system that includes an image sensor configured to capture image frames from a vehicle, a memory storing instructions, and a processor. The processor may be configured to execute the instructions to receive a predicted depth map determined by a model; determine differences between the predicted depth map and a depth mask, where the depth mask is predetermined to include values indicating probabilities that corresponding regions of the predicted depth map are sky regions; determine, based on the differences, a first loss term for the predicted depth map; and train the model based on the first loss term.

In a twenty-eighth aspect, in combination with the twenty-seventh aspect, the sky regions are determined based on typical locations of sky within a field of view in front of a vehicle.

In a twenty-ninth aspect, in combination with one or more of the twenty-seventh aspect through the twenty-eighth aspect, the probabilities of the depth mask are higher for higher vertical regions of the depth mask.

In a thirtieth aspect, in combination with one or more of the twenty-eighth aspect through the twenty-ninth aspect, the probabilities increase as an elliptic paraboloid within the depth mask.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus, comprising:
a memory storing processor-readable code; and
at least one processor coupled to the memory, the at least one processor configured to execute the processor-readable code to cause the at least one processor to perform operations including:
receiving a predicted depth map determined by a model;
determining differences between the predicted depth map and a depth mask, wherein the depth mask is predetermined to include values indicating probabilities that corresponding regions of the predicted depth map are sky regions;
determining, based on the differences, a first loss term for the predicted depth map; and
training the model based on the first loss term.

2. The apparatus of claim 1, wherein the sky regions are determined based on typical locations of sky within a field of view in front of a vehicle.

3. The apparatus of claim 1, wherein probabilities of the depth mask are higher for higher vertical regions of the depth mask.

4. The apparatus of claim 3, wherein probabilities increase as an elliptic paraboloid within the depth mask.

5. The apparatus of claim 4, wherein the elliptic paraboloid has an origin at or near an edge of the depth mask.

6. The apparatus of claim 1, wherein training the model further comprises adjusting a second loss term for the model based on the first loss term, wherein the second loss term is used to train the model.

7. The apparatus of claim 6, wherein adjusting the second loss term includes applying a weight to the first loss term for the predicted depth map.

8. The apparatus of claim 7, wherein the weight decreases for predicted depth maps generated later in a training process for the model.

9. The apparatus of claim 8, wherein the weight decreases according to a sigmoid weighting function during the training process.

10. A method comprising:
receiving a predicted depth map determined by a model;
determining differences between the predicted depth map and a depth mask, wherein the depth mask is predetermined to include values indicating probabilities that corresponding regions of the predicted depth map are sky regions;
determining, based on the differences, a first loss term for the predicted depth map; and
training the model based on the first loss term.

11. The method of claim 10, wherein sky regions are determined based on typical locations of sky within a field of view in front of a vehicle.

12. The method of claim 10, wherein probabilities of the depth mask are higher for higher vertical regions of the depth mask.

13. The method of claim 12, wherein probabilities increase as an elliptic paraboloid within the depth mask.

14. The method of claim 13, wherein the elliptic paraboloid has an origin at or near an edge of the depth mask.

15. The method of claim 10, wherein training the model further comprises adjusting a second loss term for the model based on the first loss term, wherein the second loss term is used to train the model.

16. The method of claim 15, wherein adjusting the second loss term includes applying a weight to the first loss term for the predicted depth map.

17. The method of claim 16, wherein the weight decreases for predicted depth maps generated later in a training process for the model.

18. The method of claim 17, wherein the weight decreases according to a sigmoid weighting function during the training process.

19. The method of claim 10, wherein the differences include different depth values between regions of the predicted depth map and corresponding regions of the depth mask.

20. The method of claim 10, further comprising, after training the model, generating, by the model, depth maps for use in controlling a vehicle based on image frames received from an imaging system coupled to the vehicle.

21. The method of claim 10, wherein the predicted depth map is determined by the model based on an image frame.

22. The method of claim 21, wherein the image frame is captured by a monocular imaging system.

23. A non-transitory computer-readable medium storing instructions that, when executed by a processor, cause the processor to perform operations comprising:
receiving a predicted depth map determined by a model;
determining differences between the predicted depth map and a depth mask, wherein the depth mask is predetermined to include values indicating probabilities that corresponding regions of the predicted depth map are sky regions;
determining, based on the differences, a first loss term for the predicted depth map; and
training the model based on the first loss term.

24. The non-transitory computer-readable medium of claim 23, wherein the sky regions are determined based on typical locations of sky within a field of view in front of a vehicle.

25. The non-transitory computer-readable medium of claim 23, wherein probabilities of the depth mask are higher for higher vertical regions of the depth mask.

26. The non-transitory computer-readable medium of claim 24, wherein probabilities increase as an elliptic paraboloid within the depth mask.

27. A system comprising:
an image sensor configured to capture image frames from a vehicle;
a memory storing instructions; and
a processor configured to execute the instructions to:
receive a predicted depth map determined by a model;
determine differences between the predicted depth map and a depth mask, wherein the depth mask is predetermined to include values indicating probabilities that corresponding regions of the predicted depth map are sky regions;
determine, based on the differences, a first loss term for the predicted depth map; and
train the model based on the first loss term.

28. The system of claim 27, wherein the sky regions are determined based on typical locations of sky within a field of view in front of a vehicle.

29. The system of claim 27, wherein probabilities of the depth mask are higher for higher vertical regions of the depth mask.

30. The system of claim 28, wherein probabilities increase as an elliptic paraboloid within the depth mask.
